(19) United States
(12) Patent Application Publication
(10) Pub. No.: US 2012/0249268 A1
(43) Pub. Date: Oct. 4, 2012

(54) Industrial process terminated communication system

(75) Inventor: Hong Yu, Hollis, NH (US)

(73) Assignee: Aboundi, Inc.

(21) Appl. No.: 13/065,854

(22) Filed: Apr. 1, 2011

(51) Int. Cl. H01P 1/26

(52) U.S. Cl. 333/81 R

(57) ABSTRACT

An industrial communication system, devices and termination standard which typically connect to a number of equipment workstations or process operations along the work flow or the conveyor line, and includes the work station data and power distribution lines running along side the cell, work flow or conveyor line. Individual data units are connected between the individual equipment and the data distribution and power distribution lines, wherein a selective flow of data is provided between and/or among the individual industrial equipment. A separate data distribution, or data trunk line is also present to provide a data path separate from data present on the power distribution line as described above, and a standardized termination and power connections are provided.

### FIELD OF THE INVENTION

The present invention relates to data communication systems, in particular, to systems and termination of industrial process multi-point data communication connections between and among process workstations and process monitor and control devices.

### BACKGROUND OF THE INVENTION

Industrial environments and processes include manufacturing or processing sub-components which are located or are arranged in parallel and/or in sequence until the end of the process. Each manufacturing or processing sub-component often communicates with other sub-components or a controller, typically a programmable logic device, e.g. a specialized computer. Due to the nature of the industrial process, such sub-components are widely physically distributed in a somewhat hostile industrial environment, yet is required to be tightly integrated to maintain efficient execution of the process, which requires flexible and easy installation and reliable operation over the lifetime of the industrial process.

At least one standard of data and power distribution among the process sub-components provides a first pair of wires dedicated exclusively to power distribution and a separate pair of wires dedicated exclusively to data communication which are bundled together with the power distribution pair of wires in a common cable. For example, according to the DeviceNet™ standard defined by the Open DeviceNet Vendor Association, data is exchanged over the data pair of wires which generally extend from a first end to a second end and have a termination resistor at each end substantially at the nominal (standardized) impedance of the data pair impedance, i.e. 120 ohms. Typically the power distribution pair of wires receives a constant power, e.g. 24 VDC of up to 16 amperes by a power connection for distribution to the process sub-components attached thereto. A sub-component is typically connected to both pairs of wires with a connector which connects to the power distribution pair and also provides connection to the data trunk. In the DeviceNet™ and other industrial bus specifications, no impedance is specified for the power distribution pair of wires, and no termination elements applied to the power distribution pair of wires.

### SUMMARY OF THE INVENTION

The present industrial communication system and devices are typically used in an industrial environment with a process that includes a number of workstations, cells or process operations along the work flow or the conveyor line, and includes the work station power distribution line running along side the work flow or conveyor line, and individual data units connected between the individual work stations and the power distribution line, and may further include a similar connection by a data unit between a process controller and the power distribution line, providing a selective flow of data is provided between and/or among the individual work stations and/or a workstation and the process controller. A separate data distribution, or data trunk line is also present to provide a data path separate from data present on the power distribution line as described above.

According to exemplary embodiments of the present invention, each of the power distribution and data distribution lines are terminated by a termination device typically placed at each end of each of the power distribution and data distribution lines. For instance, according to the Open DeviceNet Vendor Association (ODVA) standard 5-wire (2 pairs plus ‘drain’) data and power distribution cable, impedances (e.g. 120 ohms) are applied at each end of each of the data wire pair and power wire pair.

As further described in INDUSTRIAL PROCESS COMMUNICATION SYSTEM, Ser. No. 12/925,775, filed Nov. 1, 2010 and incorporated herein by reference, further inventive embodiments of the present invention include a secondary or redundant power distribution line to which the individual data units may also be connected and data selectively transmitted therethrough for additional bandwidth, alternate control signals or a substitute primary data path in the event of primary power line failure or deteriorated transmission quality. Moreover, further embodiments include the powering of the data units from power derived from the power distribution line(s), and integration and/or embedding some or all of the communications elements of the present invention into the structure, e.g. circuit boards, of the workstations and other devices connected to primary and/or secondary power lines.

The embodiments of the present invention provide a robust, reliable, flexible, easily installed or modified, and relatively low cost communication system operable together with hardware and signaling protocols of prior standardized systems to provide additional features of the present invention.

### BRIEF DESCRIPTION OF THE DRAWING

These and further features of the present invention will be better understood by reading the following Detailed Description together with the Drawing, wherein

FIG. 1 is a block diagram of an exemplary embodiment of a data distribution system according to the present invention;

FIG. 2 is a schematic diagram of one embodiment of a terminator according to the present invention; and

FIG. 3 is a schematic diagram of an alternate embodiment of a terminator according to the present invention.

### DETAILED DESCRIPTION

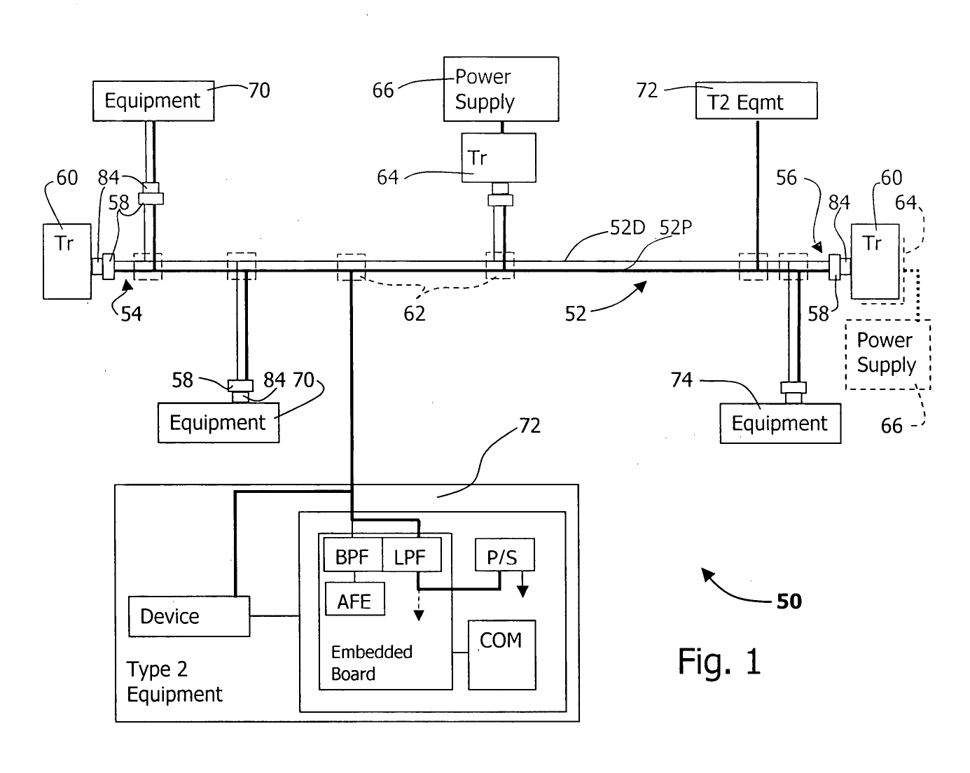

An exemplary system 50 according to the present invention is shown in FIG. 1, wherein a cable 52 is dispose along an industrial process line and has a first end 54 and a second end 56. The cable 52 includes a data distribution path 52D typically a wire pair, and a power distribution path 52P also typically a wire pair and optionally additional wires and/or shielding, etc. as may be desired, such as a common ground or ‘drain’ wire, each typically extending the entire length from first end 54 to second end 56. According to one embodiment of the present invention, either or both the data distribution path 52D or the power distribution path 52P convey data thereover and accordingly, each of the data distribution path 52D and the power distribution path 52P are terminated at ends 54 and 56 thereof with terminators 60.

The power distribution path 52P is energized with system 50 power, typically up to 48 VDC by a power supply 66 disposed between the ends 54 and 56 of the cable 52 and connected to the power distribution path via a terminator 64 which is connected to the power distribution path 52P and optionally the data distribution path 52D. Optionally, the power supply may be connected to an end, e.g. at 56 via a terminator 64 in place of the terminator 60.

Equipment 70 which conforms to the signaling standards of the cable, e.g. ODVA DeviceNet™ protocol, may be connected to both data distribution lines 52D and power distribution lines 52P as provided by that standard along those lines at “T” junction boxes, barrier connectors, etc. 62, as may equipment 72 which communicates via the power distribution lines 52P may be connected, as is further described by co-pending application Ser. No. 12/925,775 referenced above and incorporated herein. Moreover, equipment 74 which communicates by data over both the data distribution path 52D and the power distribution path 52P (e.g. as defined by the above mentioned standards). Typically the equipment 70, 72 and/or 74 presents an impedance to the respective paths substantially at the value of the respective path impedance to avoid signal reflections along the respective path.

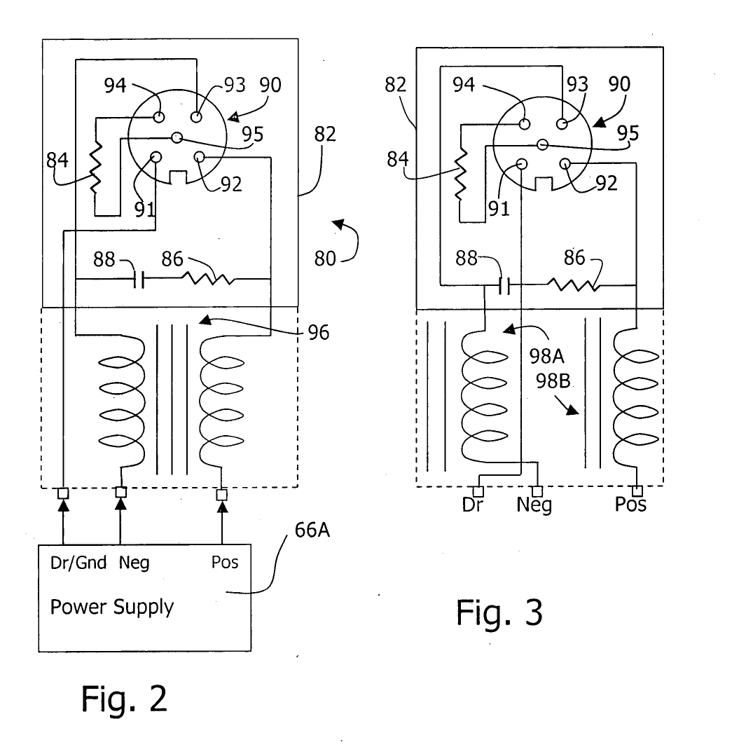

An exemplary terminator 80 is shown in FIG. 2 and typically comprises a housing 82 and a connector 90 disposed on the housing 82, and having pins 91, 92, 93, 94 and 95 corresponding to the exemplary male “micro-sealed” connector of the ODVA DeviceNet™ standard. A data distribution path terminating resistor 84, typically 121 ohms for the ODVA DeviceNet™ standard is connected to pins 94 and 95. According to the present invention, the impedance of the power distribution path (e.g. 52P) and a terminating impedance is selected accordingly for the typical DeviceNet™ cabling, typically a second 121-ohm resistor 86 connected across terminals 2 and 3, but with a DC-blocking capacitor 88 in series with the resistor 86. The DC-blocking capacitor 88 is chosen to be large (e.g. 0.01 microfarads) enough to provide relatively insignificant impedance at the data signal frequencies used.

Optionally, a power supply 66A may be connected to provide power the power distribution lines 52P via connector 90 pins 92 and 93 via a balanced ‘common mode’ inductor 96 having 2 windings, connected to provide the 2 power supply paths (to connections 91 and 92), wound around a common core or air space,

An alternative embodiment 84 of the terminator and shown in FIG. 3 is generally consistent with the embodiment 80 of FIG. 2, but having two inductor 98A and 98B wound around their own core or air space, and may be mutually coupled or magnetically isolated from each other. The inductors 96 and 98A, 98B provides a low resistance at the DC while a relatively high impedance at data frequencies so that the connection of the power supply 66A does not shunt the data signals which may be on the power distribution path with a low power supply impedance at the data frequencies, and may further reduce unwanted signal, e.g. switching power supply transients, from entering the power distribution lines 52P. Additional low-pass filter elements may also be included in association with the inductor 96 or inductors 98A, 98B. Furthermore, termination impedances other than 120 ohms, such as 100 to 220 ohms or otherwise that may correspond to the impedance of the data distribution line impedance and the power distribution line impedance.

Other connectors such as the ‘mini-sealed’ and ‘open styled’ connectors, connector elements or connector gender, and cable types, sizes and impedances as provided by the ODVA DeviceNet™ specifications, and other networks such as Profibus™ of Siemens AG, Interbus-S™ of Benden, Inc, GeniusBus of General Electric Company, Modubus™ of Modbus Organization, Fieldbus™ of Fieldbus Foundation, CANbus of Robt. Bosch GmbH, Seriplex of Belden, Inc., SDS™ of SDS Council, Honeywell Micro Switch Div., and others bus structures which have a data path and a separate power path, or have a data path and a separate power path is added, are within the scope of the present invention. Further modifications and substitutions by one of ordinary skill are within the scope of the present invention which is not to be limited except by the claims which follow.

What is claimed is:

1. A data terminator, comprising:
a housing;
a connector providing a plurality of conductive paths;
a first impedance termination disposed within said housing and connected to a first connector conductive path and a second connector conductive path, providing a selected impedance across said first and said second conductive paths; and
a second impedance termination disposed within said housing and connected to a third connector conductive path and a fourth connector conductive path, providing a DC block and a selected impedance across said third and fourth conductive paths.

2. The data terminator of claim 1, wherein said connector comprises one of a barrier strip, a male plug and a female socket.

3. The data terminator of claim 1, wherein at least one of said first impedance termination and said second impedance termination substantially comprises an impedance of 100 to 220 ohms.

4. The data terminator of claim 1, wherein said second impedance termination comprises a resistor and a series-connected capacitor.

5. The data terminator of claim 1, further including an external power path connected to said third connector conductive path and said fourth connector conductive path.

6. The data terminator of claim 5, wherein said external power path includes a low-pass filter.

7. The data terminator of claim 6, wherein said external power path low-pass filter includes at least one series-connected inductor.

8. A data and power distribution system, comprising:
a data distribution path having a nominal impedance and comprising at least a first data conductor and a second data conductor;
a power distribution path having a nominal impedance and comprising at least a first power conductor and a second power conductor, wherein said data distribution path and said power distribution path are proximal and generally follow a common route; and
a terminator including
a first impedance termination connected to said first data conductor, providing a selected impedance to said data distribution path, and
a second impedance termination connected to said first power connector conductor and said second power conductor, providing a DC block and a selected impedance to said power distribution path.

9. The data and power distribution system of claim 8, wherein at least one of said power distribution path and said terminator includes a connector providing connection of said first impedance termination to said data distribution path and connection of said second impedance termination to said power distribution path.

10. The data distribution system claim 9, wherein said connector includes at least a portion of an open style connector, a mini-sealed connector and a micro-sealed connector according to the ODVA DeviceNet™ standard.

11. The data distribution system of claim 9 wherein said terminator includes a power supply connection circuit providing a DC path from a power supply to said power distribution path.

12. The data distribution system of claim 11, wherein said power supply connection circuit includes a low-pass filter reducing the transfer of high frequency signals between said power distribution path and said power supply.

13. The data distribution system of claim 9 further including a plurality of equipment connected to said data distribution path and said power distribution path wherein power is received by said equipment from said power distribution path and data is exchanged by said equipment over said data distribution path from one equipment to another equipment.

14. The data distribution system of claim 13, wherein at least one of said equipment further exchanges data over said power distribution path another of said equipment.

15. The data distribution system of claim 9 further including a plurality of equipment connected to said data distribution path and said power distribution path wherein power is received by said equipment from said power distribution path and data is also exchanged by said equipment over said power distribution path from one equipment to another equipment.

16. A method of data and power distribution, comprising:
providing a data transmission path having a nominal impedance;
providing a DC power distribution path substantially co-located with said data transmission path, and having a nominal non-DC impedance;
terminating said data transmission path; and
terminating said DC power distribution path.

17. The method of claim 16, further including providing a flow of data over said DC power distribution path.

18. The method of claim 16, wherein said step of terminating said data transmission path and terminating said DC power distribution path includes terminating said data transmission step and terminating said power distribution path with proximally located data transmission path and DC power distribution path terminations.

19. The method of claim 18, further including the step of connecting said proximally located terminations to said substantially co-located data distribution and power distribution paths with a common connector.

20. The method of claim 16, further including the step of introducing DC power to said power distribution path from a power supply via a power distribution path termination.
